(19) United States
(12) Patent Application Publication
(10) Pub. No.: US 2019/0034968 A1
(43) Pub. Date: Jan. 31, 2019

(54) Interactive Advertisement Method and System

(71) Applicants: Inventec (Pudong) Technology Corporation, Shanghai (CN); INVENTEC CORPORATION, Taipei City (TW)

(72) Inventor: Chin-Yi WU, TAIPEI CITY (TW)

(21) Appl. No.: 15/851,699

(22) Filed: Dec. 21, 2017

(30) Foreign Application Priority Data
Jul. 27, 2017 (CN) 201710622797.2

(51) Int. Cl. G06Q 30/02

(52) U.S. Cl. CPC G06Q 30/0267; G06Q 30/0209; G06Q 30/0277; G06Q 30/0261

(57) ABSTRACT

The present invention provides an interactive advertisement method. At first, an interactive advertisement with an interactive game is formed in an advertisement platform according to an advertisement content. Next, the advertisement platform sends this interactive advertisement to a handheld device. The handheld device captures instant location information and instant image information at a specific position according to a task assignment of the interactive game. Then, based on the instant location information and the instant image information, the handheld device determines whether the task assignment is completed. When the task assignment has been completed, the handheld device transmits the instant location information and the instant image information to the advertisement platform for a secondary verification. Thereafter, the advertisement platform sends a verification code to the handheld device for exchanging a prize.

### RELATED APPLICATIONS

This application claims priority to Chinese Application Serial Number 201710622797.2, filed on Jul. 27, 2017, which are herein incorporated by reference.

### BACKGROUND

### Field of Invention

The present invention is related to an advertisement method and a system thereof, and more particularly, to an interactive advertisement method and a system thereof.

### Description of Related Art

Highly effective advertisement marketing tools can bring considerable business opportunities and create a lot of profits for advertisers. However, most of conventional advertisement marketing tools adapt passive advertisement methods. For example, the advertisers promote their products to the public through different media, such as newspapers, leaflets, websites and television imagery. There is no interaction with the customers in such a passive advertisement method. That is, the consumers are in a passive position to receive advertisement information, and the advertisers have no ways to know the consumer's perception with the products. Therefore, the effect of the passive advertisement method is limited. If the advertisers want to enhance the consumer's product impression, the advertisers need to invest more capital in advertisement activities. However, such an advertisement method may shrink product profits. On the other hand, in the passive advertisement method, the consumers receive the advertisement information passively. Therefore, it is very difficult to attract the consumers interest to browse the advertisement to achieve advertisement effects.

For the foregoing reasons, the present invention provides an advertisement platform that can interact with consumers to improve their purchase intention.

### SUMMARY

The present invention is to provide an interactive advertisement method. At first, an interactive advertisement is formed in an advertisement platform according to advertisement contents. The interactive advertisement includes an interactive game. Next, the advertisement platform sends this interactive advertisement to a handheld device. The handheld device captures instant location information and instant image information at a specific position according to a task assignment of the interactive game. Then, based on the instant location information and the instant image information, the handheld device determines whether the task assignment is completed. When the task assignment has been completed, the handheld device transmits the instant location information and the instant image information to the advertisement platform for secondary verification. Thereafter, the advertisement platform sends a verification code to the handheld device. The verification code is used for exchanging prize.

In one embodiment, the verification code is a QR code.

In an embodiment, an operation of capturing the instant location information at the specific position by the handheld device further includes using a global positioning system (GPS) of the handheld device to capture a geographical coordinate of the handheld device.

In an embodiment, an operation of capturing the instant image information at the specific position further includes using an image capturing module of the handheld device to capture the instant image information.

In an embodiment, the task assignment further includes designated location information and designated image information. The handheld device compares the instant location information with the designated location information, and compares the instant image information with the designated image information to determine whether the task assignment is completed.

In an embodiment, the present invention further includes using the handheld device to retrieve sound information according to the task assignment of the interactive game.

The present invention further provides an interactive advertisement system including an advertisement platform and a handheld device. This advertisement platform is used to create an interactive advertisement based on advertisement contents. The interactive advertisement includes an interactive game. The handheld device includes a communication component, a processor, a positioning module and an image capturing module. The communication component establishes a data transmission link with the advertisement platform to receive the interactive advertisement information from the advertisement platform. The processor analyzes and plays the interactive advertisement information on the handheld device. The positioning module captures instant location information at a specific position based on the task assignment in the interactive game. The image capturing module captures instant image information for a particular location based on the task assignment in the interactive game. This processor determines whether the task assignment is completed based on the instant location information and the instant image information. When the task assignment is completed, the processor transmits the instant location information and the instant image information to the advertisement platform for a secondary verification through the data transmission link. The advertisement platform transmits a verification code to the handheld device. The verification code is used for exchanging prizes.

In an embodiment, the verification code is a QR code, and the advertisement platform further comprises a verification code generator to generate a QR code to transmit to the handheld device after the secondary verification is completed.

In an embodiment, the handheld device further comprises a storage module for storing designated location information and designated image information of the task assignment, the processor compares the instant location information with the designated location information, and compares the instant image Information with the designed image information to determine whether the task assignment is completed.

In an embodiment, the handheld device further comprises sound information capturing module for capturing sound information based on the task assignment.

In sum, by introducing an interactive game in the advertisement contents, the consumer may use his handheld device to retrieve instant location information and instant image information at a specific position while viewing the advertisement, so as to complete the task assignment of the interactive game and get feedback rewards to exchange prizes. Accordingly, the consumer's intention to watch the advertisement may be increased, thereby improving advertisement efficiency.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart of an interactive advertisement method according to an embodiment of the present invention; and

FIG. 2 is a schematic diagram of an interactive advertisement system according to an embodiment of the present invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and elements are schematically depicted in order to simplify the drawings. Wherever possible, the same reference numbers are used in the drawings and the description to refer to the same or like parts.

The present invention provides an advertisement platform and a method for interacting with a consumer by connecting a game in the advertisement contents, the consumer may use a hand-held device to get location information, image information, or sound information when the consumer views the advertisement contents through the hand-held device to interact with the connected game. Meanwhile, an advertisement owner may send a corresponding award to the consumer based on the results of consumer interaction. Accordingly, the consumer may get incentives to improve his or her willing to browse the advertisement.

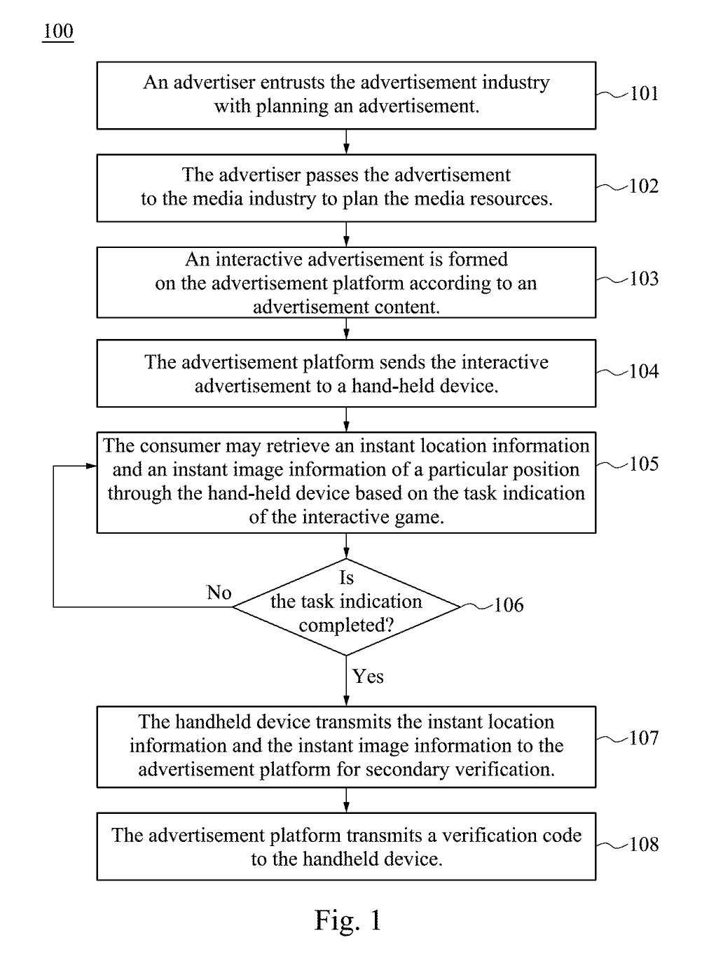

FIG. 1 is a flow chart of an interactive advertisement method according to an embodiment of the present invention. It is worthy to be noted that the interactive advertisement method may be implemented by an advertisement system, or may be implemented as a computer program and stored in a computer readable recording medium. Accordingly, the computer or server reads the recording medium to execute this method. The computer readable recording medium can be a read-only memory, a flash memory, a floppy disk, a hard disk, a CD, a flash drive, a tape, an accessible database or any computer readable recording medium with the same function that a personal skilled in the art can easily think. In this method 100, at step 101, an advertiser entrusts the advertisement industry with planning an advertisement. Next, at step 102, the advertiser passes the advertisement to the media industry to plan media resources. The media industry may create an interactive advertisement that can interact with the consumer through the advertisement platform of the present invention. That is, at step 103, an interactive advertisement is formed on the advertisement platform according to advertisement contents. The interactive advertisement includes an interactive game. At step 104, the advertisement platform sends the interactive advertisement to a hand-held device. In one embodiment, the interactive advertisement is sent to the hand-held device by means of an Application (APP) by the advertisement platform. In an embodiment, the interactive advertisement may include an interactive game, such as a guessing game or a treasure hunt game, associated with the advertisement contents. The interactive game has a task assignment that indicates designated location information and designated image information and requires the consumer to use his handheld device to search for the designated location information and to catch the designated image information or the sound information to complete this task assignment.

Accordingly, at step 105, the consumer may retrieve an instant location information and image information at a specific position through the hand-held device based on the task assignment of the interactive game. For example, the consumer may use a positioning module of the handheld device to capture instant location information at the specific position and use an image capturing module of the handheld device to capture instant image information. In an embodiment, the instant location information is a geographic coordinate value at this specific position, and the instant image information is an image of a particular object. Thereafter, at step 106, the hand-held device determines whether the task assignment is completed according to the instant location information and the instant image information. In one embodiment, a preliminary verification may be performed by the application (APP) sent to the handheld device through the advertisement platform. The APP compares the instant location information with the designated location information and compares the instant image information with the designated image information to determine whether the task assignment is completed. That is, the APP confirms whether the consumer has correctly solved the answer. At step 107, when the APP determines that the task assignment has been completed, the handheld device transmits the instant location information and the instant image information to the advertisement platform for secondary verification. That is, when the application (APP) confirms that the consumer has correctly found the answer, the instant location information, the instant image information and/or the sound information obtained by the hand-held device may be transmitted to the advertisement platform through the hand-held device for a secondary verification. Then, the instant location information and the instant image information are compared with the designated location information and the designated image information again by the advertisement platform, so as to ensure that the consumer does not cheat on the game and to control the number of rewards sent. On the other hand, if the hand-held device determines that the task assignment is not completed at step 106, that is, the captured instant location information and the instant image information do not match with the designated location information and the designated image information, the step 105 is performed again to retrieve another instant location information and another instant image information at another position according to the task assignment in the interactive game. Thereafter, at step 108, the advertisement platform transmits a verification code to the handheld device. The verification code is used to exchange the rewards awarded from the advertisement platform. In other words, after the advertisement platform determines the retrieved instant location information and instant image information are correct, the verification code, such as a QR Code, is sent to the consumer handheld device by the advertisement platform. The verification code is a unique value. Therefore, the verification code can prevent false collecting and double collecting. In other words, if the advertisement platform determines that the secondary verification is not correct, the advertisement platform will not send the verification code to the consumers handheld device. Accordingly, by this method of the present invention, when viewing the advertisement contents, the consumer not only can receive the advertisement information but also may interact with the advertisement content through his or her hand-held device to improve the consumer impression for the advertisement contents.

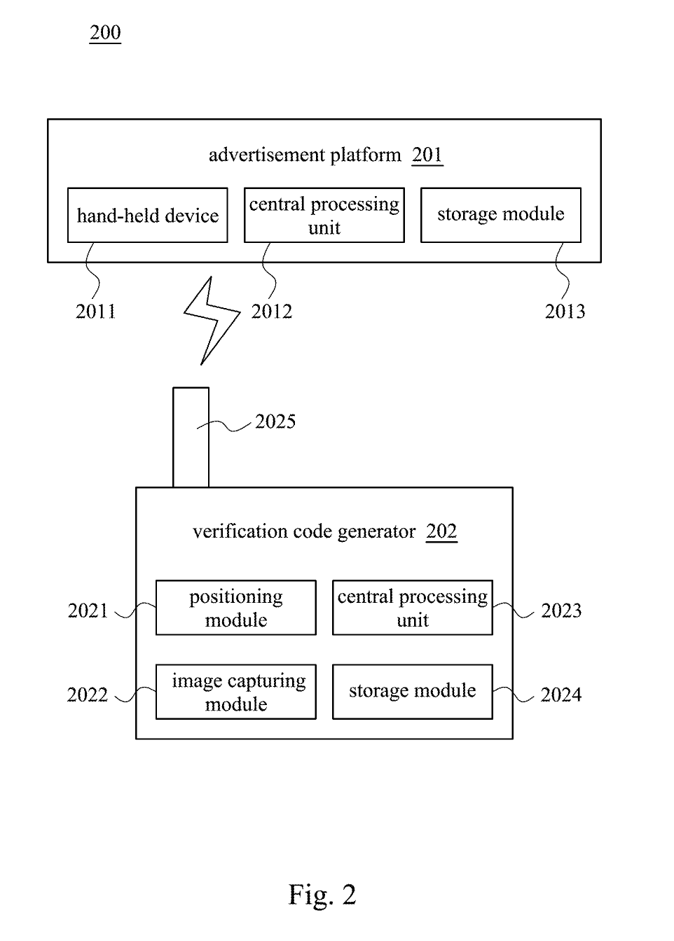

FIG. 2 is a schematic diagram of an interactive advertisement system according to an embodiment of the present invention. The interactive advertisement system 200 includes an advertisement platform 201 and a hand-held device 202. In an embodiment, the advertisement platform 201 is a server with a central processing unit 2011, a storage module 2012, and a verification code generator 2013. The central processing unit 2011 generates an interactive advertisement that interacts with the consumer. The advertisement platform 201 utilizes an application (APP) to send the interactive advertisement to the handheld device 202. This interactive advertisement includes an interactive game, such as a guessing game or a treasure hunt game, associated with the advertisement contents. The interactive game has a task assignment. The storage module 2012 stores designed location information and designed image information associated with the task assignment. The central processing unit 2011 may use the designated location information and the designated image information to perform a second verification for the instant location information and the instant image information transmitted by the hand-held device 202. The verification code generator 2013 generates a verification code, such as a QR Code, after the central processing unit 2011 confirms that the secondary verification is correct.

The hand-held device 202 is a mobile phone which includes a positioning module 2021, an image capturing module 2022, a central processing unit 2023, a storage module 2024, and a communication component 2025. The communication component 2025 includes an antenna and a corresponding circuit (not shown in the Figs.). The communication component 2025 may establish a data transmission link with the advertisement platform 2021 to receive the interactive advertisement information or a verification code transmitted by the advertisement platform 2021, and to transmit the instant location information captured by the positioning module 2021 and the instant image information captured by the image capturing module 2022 to the advertisement platform 2021. The central processing unit 2023 is a microprocessor, a control unit, or other hardware device that may execute instructions. The central processing unit 2023 may analyze and execute the interactive advertisement information downloaded from the advertisement platform 201, so as to play the interactive advertisement information on the handheld device 202. The positioning module 2021 is coupled to the communication component 2025 to retrieve instant location information at a specific position based on the task assignment of the interactive game. The positioning module 2021 may receive, decode and calculates the position signal transmitted by a plurality of satellites of the global satellite positioning system (GPS) through the communication component 2025 to obtain the instant location information of the handheld device 202 located. In one embodiment, this location information is the geographical coordinates of the latitude and longitude. In addition, the instant location signal of the handheld device 202 may also be received from other suitable positioning systems, and is not limited to the Global Satellite Positioning System (GPS) as illustrated in this example. The image capturing module 2022 captures instant image information at a specific position according to the task assignment. In an embodiment, the image capturing module 2022 is a camera for capturing image information and sound information. The storage module 2024 is a memory element for storing designated location information and designated image information indicated by a task assignment. The central processing unit 2023 compares the designated location information with the instant location information retrieved by the positioning module 2021, and compares the designated image information stored in the storage module 2024 with the instant image information captured by the image capturing module 2022 to determine whether the task assignment of the interactive game has been completed. Accordingly, when the central processing unit 2023 determines that the task assignment of the interactive game has been completed, the central processing unit 2023 transmits the instant location information and the instant image information to the advertisement platform 201 again through the communication component 2025 for second verification by the center processing unit 2011 of the advertisement platform 201. After the advertisement platform 201 performs the second verification and confirms it correctly, the central processing unit 2011 drives the verification code generator 2013 to generate the verification code, such as a QR Code, to send to the handheld device 202.

In sum, by introducing an interactive game in the advertisement content, the consumer may use the handheld device to retrieve instant location information and instant image information at a specific position while viewing the advertisement to complete the task assignment of the interactive game and get feedback rewards to exchange prizes. Accordingly, the consumers intention to watch the advertisement may be increased and the consumer's participation state may be well understood through the participation state of the interactive game, so as to improve advertisement efficiency.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An interactive advertisement method, comprising:
forming an interactive advertisement on an advertisement platform according to an advertisement content, wherein the interactive advertisement includes an interactive game;
sending the interactive advertisement to a handheld device by the advertisement platform;
capturing instant location information and instant image information at a specific position by the handheld device according to a task assignment of the interactive game;
determining whether the task assignment is completed by the handheld device according to the instant location information and the instant image information;
transmitting the instant location information and the instant image information to the advertisement platform by the handheld device for a secondary verification when the task assignment has been completed; and
transmitting a verification code to the handheld device by the advertisement platform, wherein the verification code is used for exchanging a prize.

2. The interactive advertisement method of claim 1, wherein the verification code is a QR code.

3. The interactive advertisement method of claim 1, wherein capturing the instant location information and the instant image information at a specific position by the handheld device further comprises: using a global positioning system (GPS) of the handheld device to capture a geographical coordinate of the handheld device.

4. The interactive advertisement method of claim 1, wherein capturing the instant location information and the instant image information at a specific position by the handheld device further comprises: using an image capturing module of the handheld device to capture the instant image information.

5. The interactive advertisement method of claim 1, wherein the task assignment further comprises designated location information and designated image information, wherein the handheld device compares the instant location information with the designated location information, and compares the instant image information with the designated image information to determine whether the task assignment is completed.

6. The interactive advertisement method of claim 1, further comprising using the handheld device to retrieve sound information according to the task assignment of the interactive game.

7. An interactive advertisement system, comprising:
an advertisement platform configured to form an interactive advertisement based on an advertisement content, wherein the interactive advertisement includes an interactive game; and
a handheld device, comprising:
a communication component, wherein the communication component establishes a data transmission link with the advertisement platform to receive the interactive advertisement from the advertisement platform;
a processor, configured to analyze and play the interactive advertisement on the handheld device;
a positioning module configured to capture instant location information at a specific position based on a task assignment in the interactive game; and
an image capturing module configured to capture instant image information for the specific position based on the task assignment in the interactive game,
wherein the processor determines whether the task assignment is completed based on the instant location information and the instant image information, and
when the task assignment is completed, the processor transmits the instant location information and the instant image information to the advertisement platform for a verification through the data transmission link, and the advertisement platform transmits a verification code to the handheld device, wherein the verification code is used for exchanging a prize.

8. The interactive advertisement system of claim 7, wherein the verification code is a QR code, and the advertisement platform further comprises a verification code generator to generate the QR code to transmit to the handheld device after the secondary verification is completed.

9. The interactive advertisement system of claim 7, wherein the handheld device further comprises a storage module configured to store designated location information and designated image information of the task assignment and the processor compares the instant location information with the designated location information, and compares the instant image Information with the designed image information to determine whether the task assignment is completed.

10. The interactive advertisement system of claim 7, wherein the handheld device further comprises a sound information capturing module configured to capture sound information based on the task assignment.
